(19) United States
(12) Patent Application Publication
(10) Pub. No.: US 2022/0009235 A1
(43) Pub. Date: Jan. 13, 2022

(54) CLEANING METHOD OF FLOW PATH IN INKJET HEAD, INKJET HEAD, CLEANING DEVICE, AND IMAGE FORMING DEVICE

(71) Applicant: Konica Minolta, Inc., Tokyo (JP)

(72) Inventors: Junji UJIHARA, Tokyo (JP); Yasuharu SAITA, Tokyo (JP)

(21) Appl. No.: 17/353,765

(22) Filed: Jun. 21, 2021

(30) Foreign Application Priority Data
Jul. 13, 2020 (JP) 2020-120205

(51) Int. Cl. B41J 2/165

(52) U.S. Cl. CPC B41J 2/16552

(57) ABSTRACT

There is provided a cleaning method of a flow path in an inkjet head, including: introducing cleaning liquid into the flow path in the inkjet head; and introducing gas into the flow path in the inkjet head, wherein bubbles made of the gas are generated in the cleaning liquid introduced into the flow path.

The entire disclosure of Japanese patent Application No. 2020-120205, filed on Jul. 13, 2020, is incorporated herein by reference in its entirety.

### BACKGROUND

### Technological Field

The present invention relates to a cleaning method of a flow path in an inkjet head, a cleaning device, and an image forming device.

### Description of the Related Art

Conventionally, an inkjet head used in an industrial printing machine is required to eject ink for a long time in order to mass-produce printed matters.

Ink and varnish used in the industrial printing machines have higher viscosity than that of ink used in printers, and tend to stay in a flow path in the inkjet head. The ink and varnish contain a large amount of solid contents. Therefore, especially when the ink or varnish is ejected for a long time, the solid contents deposited due to the above-described stay tend to adhere to a wall surface of the flow path. The solid contents deposited to be fixed tend to cause clogging in the flow path in the inkjet head and an ejection unit. The above-described clogging problematically causes color unevenness and density unevenness of an image due to a missing nozzle (ink and varnish cannot be ejected from the nozzle), color mixing due to deterioration in impact position accuracy due to flight deflection of ink and varnish droplets and the like. Especially, ejection failure due to the above-described stay is likely to occur.

As a means for resolving the clogging in the flow path or the ejection port, there is a method of running with ink or varnish without putting in paper (a method of ejecting ink or varnish other than the time of printing). However, there is a problem that this running takes time, involves consumption of ink and varnish, and has low efficiency of removing adhered substances. Therefore, effectiveness of a cleaning method of the flow path in the inkjet head with cleaning liquid containing bubbles as one of cleaning methods of suppressing the clogging of the flow path in the inkjet head and the ejection unit has been reported.

There are various cleaning methods of the flow path in the inkjet head and the ejection unit with the cleaning liquid containing the bubbles.

For example, JP 2012-103389 A discloses the cleaning unit that cleans the print head and the ink supply tube. According to JP 2012-103389 A, the gas-liquid two-phase agent is generated by mixing the cleaning liquid and gas, and when the gas-liquid two-phase agent is supplied to the print head and the ink supply tube, the bubbles in the cleaning liquid collide with each other and disturb the liquid flow, so that the cleaning performance is improved.

JP 2010-228297 A discloses the cleaning method of cleaning the inside of the droplet ejection device using the cleaning liquid in which the bubbles are mixed. According to JP 2010-228297 A, the cleaning performance is improved by adjusting the bubble diameter and making the bubbles fine when the bubbles are mixed into the cleaning liquid.

JP 2016-16550 A discloses the cleaning device of the droplet ejection unit provided with the cleaning means of immersing the droplet ejection unit in the cleaning liquid for cleaning and the like. According to JP 2016-16550 A, it is possible to generate the fine bubbles to clean by supplying heat energy to the cleaning liquid in which the droplet ejection unit is immersed.

As in JP 2012-103389 A, JP 2010-228297 A, and JP 2016-16550 A, the cleaning method of the inside of the inkjet head is known.

However, according to the findings of the present inventors, even though the inkjet head is cleaned by the methods disclosed in JP 2012-103389 A, JP 2010-228297 A, and JP 2016-16550 A, occurrence of the missing nozzle and deterioration in ink impact position accuracy are not yet resolved.

### SUMMARY

The present invention is achieved in view of the above-described circumstances, and an object thereof is to provide a cleaning method of a flow path in an inkjet head and a cleaning device capable of resolving occurrence of a missing nozzle of an inkjet head and deterioration in ink impact position accuracy, and an image forming device provided with the cleaning device.

To achieve the abovementioned object, according to an aspect of the present invention, there is provided a cleaning method of a flow path in an inkjet head, and the cleaning method reflecting one aspect of the present invention comprises: introducing cleaning liquid into the flow path in the inkjet head; and introducing gas into the flow path in the inkjet head, wherein bubbles made of the gas are generated in the cleaning liquid introduced into the flow path.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic diagram illustrating a configuration of an image forming device of a first embodiment;

FIG. 2 is an exploded perspective view illustrating an outline of an inkjet head of the first embodiment;

FIG. 3 is a cross-sectional view taken along line A-A in FIG. 2 illustrating an outline of a head chip included in the inkjet head of the first embodiment;

FIG. 4 is a cross-sectional view taken along line B-B in FIG. 2 illustrating the outline of the head chip included in the inkjet head of the first embodiment;

FIG. 5 is a top view illustrating a configuration in the vicinity of the inkjet head in the image forming device of the first embodiment;

FIG. 6 is a block diagram illustrating a principal functional configuration of the image forming device;

FIG. 7 is a schematic diagram illustrating an aeration cleaning mechanism;

FIG. 8 is an exemplary flowchart of a cleaning method in this embodiment;

FIG. 9 is a schematic diagram illustrating a configuration of an image forming device of a second embodiment; and

FIG. 10 is an exploded perspective view illustrating an outline of an inkjet head of the second embodiment.

### DETAILED DESCRIPTION OF EMBODIMENTS

Hereinafter, one or more embodiments of the present invention will be described with reference to the drawings. However, the scope of the invention is not limited to the disclosed embodiments. A member common in the respective drawings is designated by the same reference sign. The present invention is not limited to the following embodiments.

### 1. First Embodiment

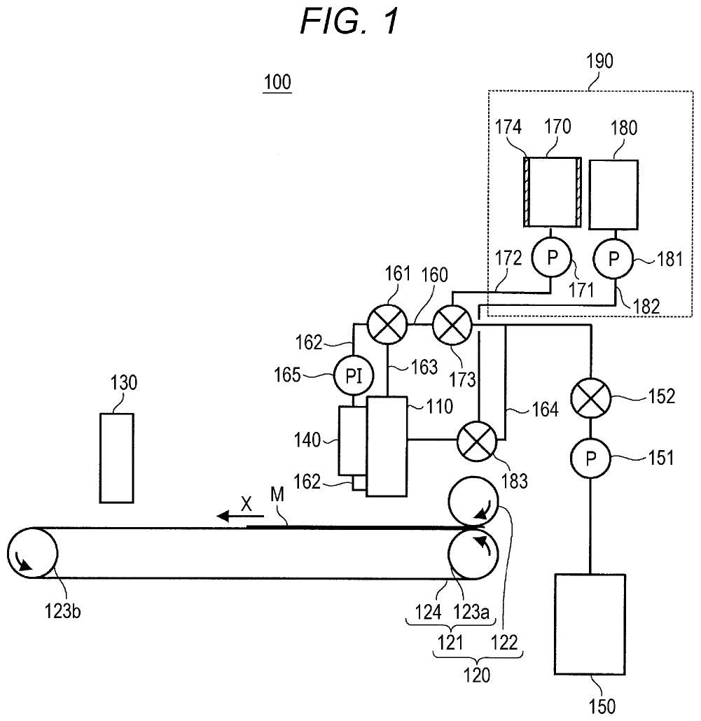

FIG. 1 is a schematic diagram illustrating a configuration of an image forming device according to a first embodiment.

1-1 Image Forming Device

As illustrated in FIG. 1, an image forming device 100 includes an inkjet head 110, a conveyance device 120, an irradiation device 130 capable of applying an active ray, an ink supply device 140, an ink storage tank 150, an ink flow path 160, a cleaning liquid storage tank 170, and a gas storage tank 180.

The inkjet head 110 includes a plurality of nozzles for ejecting ink droplets onto a printed medium M such as paper being a printed matter. For example, the inkjet head 110 is configured so that a plurality of types of ink of different colors are supplied to specific nozzles, respectively. The inkjet head 110 is arranged so as to be scannable in a direction crossing a conveyance direction X of the printed medium M on which an image is to be formed, for example.

In this embodiment, the inkjet head 110 ejects active ray-curable inkjet ink containing pigment, a pigment dispersant, and a reactive monomer (hereinafter, when it is simply referred to as “ink” or “active ray-curable ink”, this is intended to mean the above-described active ray-curable inkjet ink). The above-described ink may be ink containing a gelling agent and reversibly undergoing sol-gel phase transition by a change in temperature. The inkjet head 110 may be a scan type inkjet head or a line type inkjet head.

The conveyance device 120 is a device for conveying the printed medium M to the inkjet head 110. The conveyance device 120 is provided with, for example, a belt conveyor 121 and a rotatable feed roller 122. The belt conveyor 121 is formed of rotatable pulleys 123a and 123b and an endless belt 124 stretched around the pulleys 123a and 123b. The feed roller 122 is arranged in a position facing the pulley 123a on an upstream side in the conveyance direction X of the printed medium M so as to interpose the belt 124 and the printed medium M between the same and the pulley 123a to feed the printed medium M onto the belt 124.

The irradiation device 130 is arranged on a downstream side of the conveyance device 120, and irradiates the ink ejected from the inkjet head to be adhered to the printed medium M with the active ray. The irradiation device 130 reacts (polymerizes) the reactive monomer contained in the ink by irradiating the same with the active ray, and forms a cured film formed by curing the ink on a surface of the printed medium M. The active ray applied by the irradiation device 130 may be an ultraviolet ray (UV), an electron beam (EV) and the like.

The ink supply device 140 is integrally arranged with the inkjet head 110. The ink supply device 140 is arranged for each type of ink. For example, when using the inks of four colors of yellow (Y), magenta (M), cyan (C), and black (K), four ink supply devices 140 are arranged on the inkjet head 110.

Each ink supply device 140 is supplied with the ink in the ink storage tank 150 via the ink flow path 160, a valve 161, and a main flow path 162. Each ink supply device 140 communicates with a common ink chamber to be described later of the inkjet head 110 via the main flow path 162, and is connected so that the ink of each color may be supplied to an ink supply port of a desired common ink chamber.

The inkjet head 110 is also connected to the ink storage tank 150 by a bypass flow path 163 branching from the above-described ink flow path 160. At a branching point between the main flow path 162 and the bypass flow path 163, the valve 161 capable of switching and setting the ink flow path to one of or both the ink flow path 160 and the bypass flow path 163 is arranged. All of the ink flow path 160, the main flow path 162, and the bypass flow path 163 are flexible tubes, for example. The valve 161 is, for example, a three-way valve.

A circulation flow path 164 is a path for returning liquid discharged from an ink discharge port 2b of the inkjet head to be described later to the ink flow path 160. At a junction of the circulation flow path 164 and a gas flow path 182 to be described later, a valve 183 capable of switching and setting so that either ink discharge from the inkjet head 110 or gas supply to the inkjet head 110 may be performed is installed, and this may be used properly at the time of ink discharge and cleaning. The circulation flow path 164 is, for example, a flexible tube. The valve 183 is, for example, a three-way valve.

The ink storage tank 150 is a storage tank for accommodating the ink to be supplied to the inkjet head 110, and supplies the ink to the inkjet head by an ink supply pump 151. The ink storage tank 150 is arranged separately from the inkjet head 110. The ink storage tank 150 includes, for example, a stirring device not illustrated. The ink storage tank 150 may be appropriately determined according to image forming performance, a size and the like of the image forming device 100. For example, in a case where an image forming speed of the image forming device is 1 to 3 m²/min, a capacity of the ink storage tank 150 is, for example, 1 L.

1-1-1. Inkjet Head

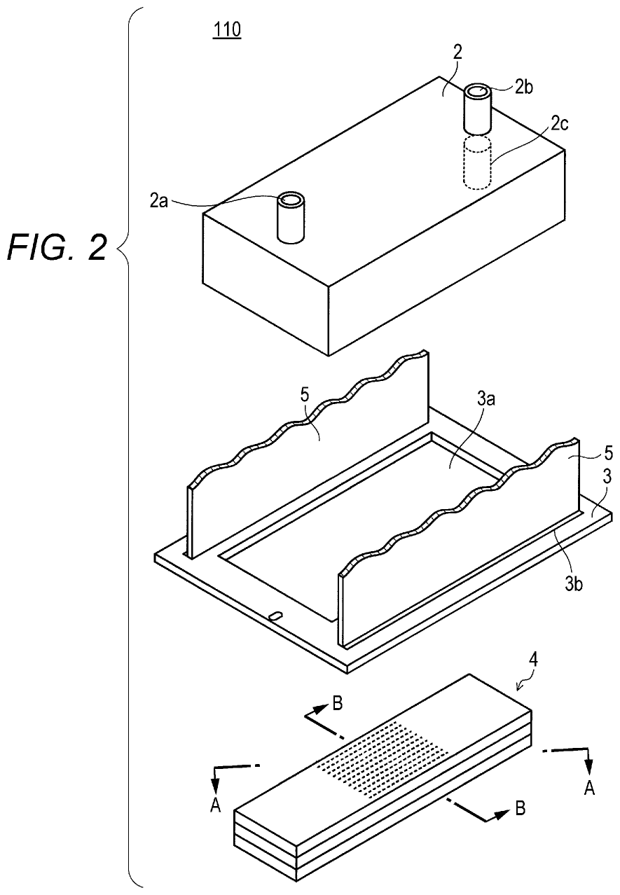

FIG. 2 is an exploded perspective view illustrating an outline of the inkjet head 110 used in the image forming device 100 described above. As illustrated in FIG. 2, the inkjet head 110 includes a common ink chamber 2, a holder 3, a head chip 4, and a flexible wiring board 5.

The common ink chamber 2 is formed into a hollow substantially rectangular parallelepiped shape, and one surface thereof facing the holder 3 is opened. An ink supply port 2a for supplying the ink from the ink supply device 140 and the ink discharge port 2b for discharging the ink to the ink supply device 140 are provided on one surface facing the above-described opening of the common ink chamber 2. The ink discharge port 2b is provided with a porous body 2c to be described later. The common ink chamber 2 is provided with a filter therein, removes foreign matters from the ink supplied from the ink supply port 2a by the above-described filter, and finely crushes bubbles contained in the ink.

The holder 3 is formed into a substantially flat plate shape with an opening 3a at substantially the center, and is arranged so as to cover the above-described opening of the common ink chamber 2. As a result, the common ink chamber 2 is connected to one surface of the holder 3 so as to cover the opening 3a. The head chip 4 is connected to the other surface of the holder 3 so as to cover the opening 3a. The holder 3 allows the common ink chamber 2 to communicate with the head chip 4 via the opening 3a.

An insertion hole 3b is provided on an outer peripheral portion of the holder 3. The flexible wiring board 5 is inserted through the insertion hole 3b. One end of the flexible wiring board 5 is connected to a wiring board 50 of the head chip 4 to be described later. The other end of the flexible wiring board 5 is inserted through the insertion hole 3b provided on the holder 3 from the other surface of the holder 3 to be pulled out toward the common ink chamber 2.

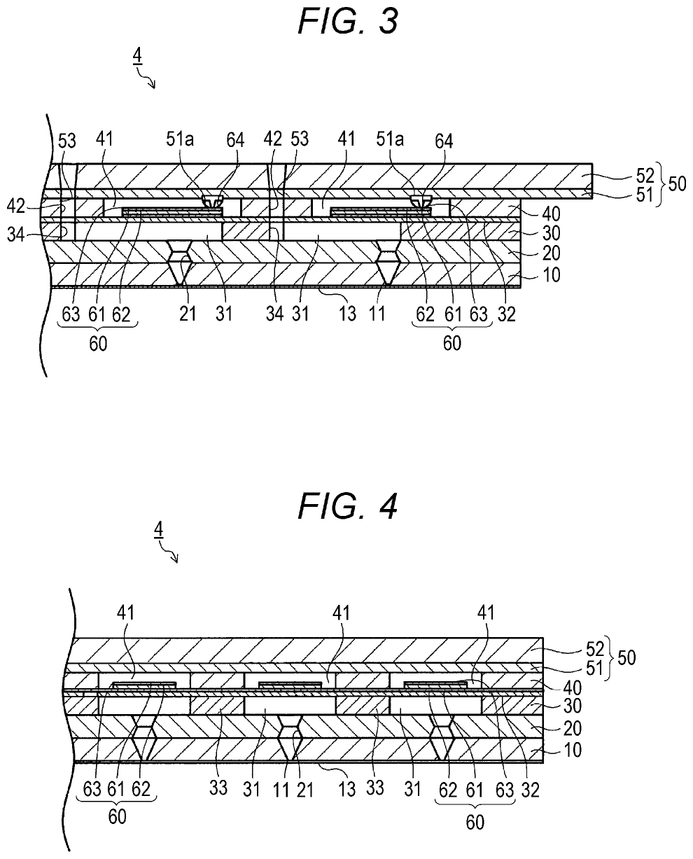

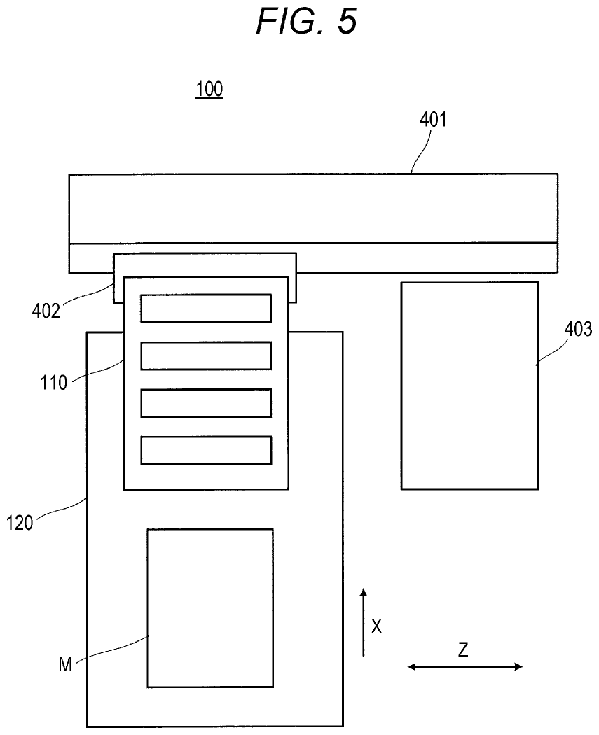

FIG. 3 is a cross-sectional view taken along line A-A in FIG. 2 illustrating an outline of the head chip 4 included in the inkjet head 110 described above, and FIG. 4 is a cross-sectional view taken along line B-B in FIG. 2 illustrating the outline of the head chip 4 included in the inkjet head 110 described above.

The head chip 4 includes a nozzle plate 10, an intermediate plate 20, a pressure chamber forming plate 30, a drive plate 40, and the wiring board 50. The head chip 4 is obtained by stacking the nozzle plate 10, the intermediate plate 20, the pressure chamber forming plate 30, the drive plate 40, and the wiring board 50 in this order from an ink ejection surface side.

A plurality of nozzle holes 11 is formed on the nozzle plate 10. The nozzle hole 11 penetrates from one surface to the other surface of the nozzle plate 10. The nozzle hole 11 has a cross-sectional shape narrowed so that a tip end side thereof serving as an ejection port has a small diameter, and ejects the ink supplied from the common ink chamber 2 from the ejection port to the outside. A plurality of (for example, 500 to 2000) nozzle holes 11 is provided on the nozzle plate 10 and arranged in a matrix pattern. The nozzle holes 11 communicates with a pressure chamber 31 formed on the pressure chamber forming plate 30 via the intermediate plate 20 stacked on the nozzle plate 10.

The intermediate plate 20 is arranged between the nozzle plate 10 and the pressure chamber forming plate 30. The intermediate plate 20 is provided with a first communication hole 21 that allows the nozzle hole 11 to communicate with the pressure chamber 31 provided on the pressure chamber forming plate 30 described later. The first communication hole 21 is provided in a position corresponding to the nozzle hole 11 of the nozzle plate 10 and penetrates from one surface to the other surface of the intermediate plate 20.

The pressure chamber forming plate 30 includes a plurality of pressure chambers 31 and a diaphragm 32. The pressure chamber 31 is provided in a position corresponding to the nozzle hole 11 of the nozzle plate 10 and the first communication hole 21 of the intermediate plate 20. The pressure chamber 31 penetrates from one surface to the other surface of the pressure chamber forming plate 30. The pressure chamber 31 applies an ejection pressure to the ink ejected from the nozzle hole 11 by volume fluctuation thereof. A partition wall 33 is formed between a plurality of pressure chambers 31.

The diaphragm 32 is arranged so as to cover an opening on the side opposite to the intermediate plate 20 of the pressure chamber 31. The diaphragm 32 is provided with a second communication hole 34 that communicates with the pressure chamber 31. The drive plate 40 is arranged on one surface on the side opposite to one surface on the pressure chamber 31 side of the diaphragm 32.

The drive plate 40 includes a space 41 and a third communication hole 42 that communicates with the second communication hole 34. The space 41 is arranged in a position facing the pressure chamber 31 with the diaphragm 32 interposed therebetween. An actuator 60 is accommodated in the space 41.

The actuator 60 includes a piezoelectric element 61, a first electrode 62, and a second electrode 63. The first electrode 62 is stacked on one surface of the diaphragm 32. An insulating layer may be arranged between the first electrode 62 and the diaphragm 32. The piezoelectric element 61 is stacked on the first electrode 62, and is arranged for each pressure chamber 31 (for each channel) in a position facing the pressure chamber 31 with the diaphragm 32 and the first electrode 62 interposed therebetween.

The piezoelectric element 61 is formed of a material that deforms by application of a voltage, and is formed of a ferroelectric material such as lead zirconate titanate (PZT), for example. The second electrode 63 is stacked on a surface on the side opposite to the first electrode 62 of the piezoelectric element 61. The second electrode 63 is connected to a wiring layer 51 provided on the wiring board 50 to be described later via a bump 64. A film thickness of the piezoelectric element 61 is, for example, 10 μm or shorter.

The wiring board 50 includes the wiring layer 51 and a silicon layer 52 on a surface of which the wiring layer 51 is formed. The wiring layer 51 is connected to the bump 64 provided on the second electrode 63 via solder 51a. An outer edge of the wiring layer 51 is connected to the flexible wiring board 5. Furthermore, the silicon layer 52 is arranged on one surface on the side opposite to the drive plate 40 of the wiring layer 51. The silicon layer 52 is joined to the holder 3.

The wiring board 50 is provided with a fourth communication hole 53 penetrating the wiring layer 51 and the silicon layer 52. The fourth communication hole 53 communicates with the common ink chamber 2 via the third communication hole 42 of the drive plate 40 and the opening 3a of the holder 3.

In this embodiment, an inlet that serves as a flow path for supplying the ink in the common ink chamber 2 to the pressure chamber 31 is formed of the fourth communication hole 53 of the wiring board 50, the third communication hole 42 of the drive plate 40, and the second communication hole 34 of the diaphragm 32 that communicates with each other. The inlet serves to narrow flow path resistance (flow rate) of the ink flowing from the common ink chamber 2 into the pressure chamber 31. An outlet for ejecting the ink in the pressure chamber 31 toward the recorded medium M is formed of the first communication hole 21 of the intermediate plate 20 and the nozzle hole 11 of the nozzle plate 10 that communicates with each other.

In the inkjet head 110 having such a configuration, the ink accommodated in the common ink chamber 2 passes through the inlet (that is, the fourth communication hole 53, the third communication hole 42, and the second communication hole 34) and flows into the pressure chamber 31. When a voltage is applied between the first electrode 62 and the second electrode 63, the piezoelectric element 61 is activated to be deformed (vibrates), and the diaphragm 32 is deformed (vibrates) as the piezoelectric element 61 is deformed. When the diaphragm 32 is deformed (vibrates), a pressure for ejecting the ink is generated in the pressure chamber 31. Due to generation of such pressure, the ink in the pressure chamber 31 is pushed out to the outlet (that is, the first communication hole 21 and the nozzle hole 11), and is ejected from the tip end (nozzle opening) of the nozzle hole 11 toward the recorded medium M.

In the present invention, a “flow path in the inkjet head” is a general term for the flow path through which the ink passes from the common ink chamber 2 to the tip end (ink ejection port) of the nozzle hole 11 in the above-described inkjet head 110. An ejection port diameter of the nozzle hole 11 is smaller than a flow path diameter in the inkjet head.

1-1-2. Cleaning Device

The image forming device 100 is equipped with a cleaning device 190 including a cleaning liquid introducer including the cleaning liquid storage tank 170, a cleaning liquid flow path pump 171, and a cleaning liquid flow path 172; a gas introducer including the gas storage tank 180, a gas flow path pump 181, and the gas flow path 182; and a bubble generator including the porous body 2c and the common ink chamber 2 of the inkjet head 110.

The cleaning liquid storage tank 170 is a storage tank for accommodating cleaning liquid supplied to the inkjet head 110. The cleaning liquid storage tank 170 is arranged separately from the inkjet head 110. When cleaning the flow path in the inkjet head 110, the cleaning liquid is supplied from the cleaning liquid storage tank 170 to the ink supply port 2a of the inkjet head 110 via the cleaning liquid flow path 172, the ink flow path 160, and the main flow path 162 or the bypass flow path 163 by the cleaning liquid flow path pump 171. At a junction of the cleaning liquid flow path 172 and the ink flow path 160, a valve 173 capable of switching and setting so that either the ink or the cleaning liquid may be supplied to the inkjet head 110 is installed, and this may be used properly at the time of ink supply and cleaning. A pressure in the inkjet head may be measured with a pressure meter 165. The cleaning liquid flow path 172 is, for example, a flexible tube. The valve 173 is, for example, a three-way valve.

A temperature adjustment device 174 is installed on an outer periphery of the cleaning liquid storage tank 170. The temperature adjustment device 174 adjusts temperature of the cleaning liquid stored in the cleaning liquid storage tank 170 at predetermined temperature. The image forming device may adjust the temperature of the cleaning liquid by heating and the like the inkjet head 110.

The gas storage tank 180 is a storage tank for accommodating gas supplied to the inkjet head 110. The gas storage tank 180 is arranged separately from the inkjet head 110. When cleaning the flow path in the inkjet head 110, the gas is supplied from the gas storage tank 180 to the ink discharge port 2b of the inkjet head 110 via the gas flow path 182 by the gas flow path pump 181. The porous body 2c is attached to the ink discharge port 2b. Since the porous body 2c is attached, bubbles generated in the above-described cleaning liquid may be made fine. The porous body 2c may be replaced with one having a different pore diameter depending on a size of the bubbles wanted to be generated. The gas flow path 182 is, for example, a flexible tube.

The porous body 2c is attached so that the gas supplied from the gas storage tank 180 passes through the porous body 2c to be supplied to the inside of the inkjet head 110 (common ink chamber 2), and this makes the above-described supplied gas fine (makes bubbles of the same). The porous body 2c may be made of ceramic including alumina, aluminum nitride, silicon nitride, boron nitride, zirconia, titania and the like, may be made of glass, may be made of metal, or may be made of resin such as foamed resin. Out of them, from the viewpoint of easily cleaning the porous body, this is preferably made of resin, and more preferably made of fluororesin.

A shape of the porous body 2c is not especially limited; this may be a two-dimensional shape such as a sheet shape, or a three-dimensional shape such as a tube shape.

An average pore diameter of the porous body 2c is preferably smaller than the flow path diameter in the inkjet head and the ejection port diameter. Specifically, this is preferably 15 μm or larger and 60 μm or smaller, more preferably 15 μm or large and 40 μm or smaller, and still more preferably 15 μm or larger and 35 μm or smaller. Therefore, the average pore diameter of the above-described porous body 2c is preferably 10 μm or larger and 30 μm or smaller, more preferably 10 μm or larger and 20 μm or smaller, and still more preferably 10 μm or larger and 15 μm or smaller.

The above-described average pore diameter is a value measured by performing image processing on an image taken by a micro high scope (DSX1000, manufactured by Olympus Corporation) with image processing software (Image-Pro Plus, manufactured by Planetron, Inc.)

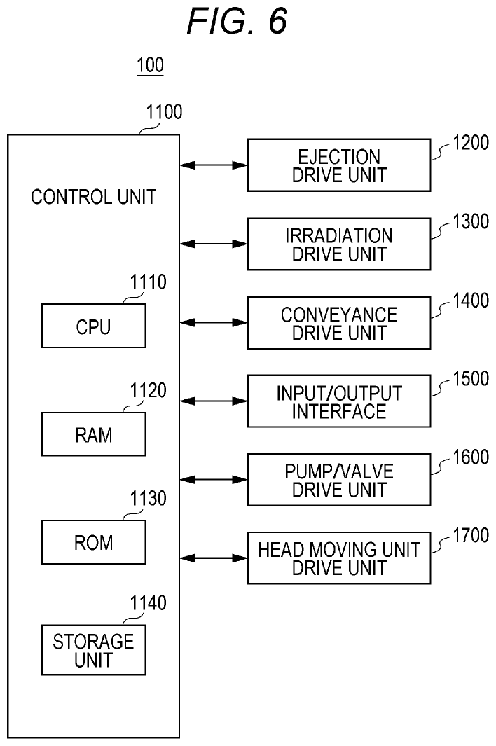

FIG. 5 is a top view illustrating a configuration in the vicinity of the inkjet head 110 in the image forming device 100.

The image forming device 100 may also include a cleaning liquid recovery container 403 that recovers the cleaning liquid discharged from the nozzle hole 11. As illustrated in FIG. 5, the cleaning liquid recovery container 403 is arranged in the vicinity of the belt 124. At the time of cleaning, the image forming device 100 may move the inkjet head 110 to a position in which the nozzle faces the recovery container by a head moving unit 402 described later, and discharge the cleaning liquid directly from the nozzle hole 11 to the cleaning liquid recovery container 403.

As illustrated in FIG. 5, the inkjet head 110 is connected to the head moving unit 402 supported by a support frame 401 extending in a moving direction Z from a portion above the conveyance device 120 to a portion above the cleaning liquid recovery container 403 and moves the inkjet head 110 in the moving direction Z. The head moving unit 402 may move the inkjet head 110 in a moving direction connecting a first position for forming the image and a second position for discharging the cleaning liquid to the cleaning liquid recovery container 403. In FIG. 5, the inkjet head 110 is in the first position, but this may be moved to the second position vertically above the cleaning liquid recovery container 403 by the head moving unit 402.

1-1-3. Functional Configuration of Image Forming Device

FIG. 6 is a block diagram illustrating a principal functional configuration of the image forming device 100. The image forming device 100 is provided with a control unit 1100, an ejection drive unit 1200, an irradiation drive unit 1300, a conveyance drive unit 1400, an input/output interface 1500, a pump/valve drive unit 1600, and a head moving unit drive unit 1700.

The control unit 1100 includes a central processing unit (CPU) 1110, a random access memory (RAM) 1120, a read only memory (ROM) 1130, and a storage unit 1140, and integrally controls an entire operation of the image forming device 100.

The CPU 1110 reads various control programs and setting data stored in the ROM 1130 and allows the RAM 1120 to store them, and executes the programs to perform various types of arithmetic processing.

The RAM 1120 provides a working memory space to the CPU 1110 to store temporary data. The RAM 1120 may include a non-volatile memory.

The ROM 1130 stores the various control programs executed by the CPU 1110, the setting data and the like. A rewritable non-volatile memory such as an electrically erasable programmable read only memory (EEPROM) and a flash memory may also be used in place of the ROM 1130.

The storage unit 1140 stores a print job input from an external device not illustrated via the input/output interface 1500, image data of an image formed by the print job and the like. As the storage unit 1140, for example, a hard disk drive (HDD) is used, and a dynamic random access memory (DRAM) and the like may be used together.

The ejection drive unit 1200 supplies a drive signal according to the image data to a recording element of the inkjet head 110 at an appropriate timing based on control of the control unit 1100, thereby allowing the nozzle of the inkjet head 110 to eject the ink of an amount according to a pixel value of the image data.

The irradiation drive unit 1300 supplies a drive signal to the irradiation device 130 at an appropriate timing based on control of the control unit 1100, thereby irradiating the printed medium M to which the ink is applied conveyed in the conveyance device 120 with an active ray for curing the ink.

Based on a control signal supplied from the control unit 1100, the conveyance drive unit 1400 supplies a drive signal to a conveyance drum motor provided on the conveyance device 120 to rotate the conveyance device 120 at a predetermined speed and timing. The conveyance drive unit 1400 supplies the printed medium M to the conveyance device 120 and discharges the same from the conveyance device 120 based on the control signal supplied from the control unit 1100.

The input/output interface 1500 operates as an input reception unit and an output unit, is connected to an input/output interface of an external device (for example, a personal computer), and mediates data transmission/reception between the control unit 1100 and the external device. The input/output interface 1500 is formed of, for example, either various serial interfaces or various parallel interfaces, or a combination thereof.

The pump/valve drive unit 1600 operates the ink supply pump 151 and opens/closes a valve 152 and the valve 161 based on the control signal supplied from the control unit 1100, thereby controlling an amount and timing of the ink that flows from the ink storage tank 150 through the ink flow path 160 to flow into the inkjet head 110. The pump/valve drive unit 1600 operates either of or both the cleaning liquid flow path pump 171 and the gas flow path pump 181 based on the control signal supplied from the control unit 1100, and opens/closes either of or both the valve 173 and the valve 183. As a result, the pump/valve drive unit 1600 controls an amount and timing of the cleaning liquid that flows through the cleaning liquid flow path 172 and the ink flow path 160 and flows from the ink supply port 2a into the inkjet head 110. As a result, the pump/valve drive unit 1600 controls an amount and timing of the gas that flows through the gas flow path 182 and the circulation flow path 164 and flows from the ink discharge port 2b into the inkjet head 110.

The head moving unit drive unit 1700 operates the head moving unit 402 based on the control signal supplied from the control unit 1100 to change the position of the inkjet head 110. Specifically, the head moving unit drive unit 1700 moves the position of the inkjet head 110 between a position in which the nozzle hole 11 faces the recorded medium M conveyed in the conveyance device 120 and the position in which the nozzle hole 11 faces the cleaning liquid recovery container 403 by the operation of the head moving unit 402.

<Cleaning Method>

A cleaning method according to the present invention is a cleaning method of a flow path in an inkjet head provided with a step of introducing cleaning liquid into the flow path in the inkjet head, and a step of introducing gas into the flow path in the inkjet head, in which bubbles made of the gas are generated in the cleaning liquid introduced into the flow path.

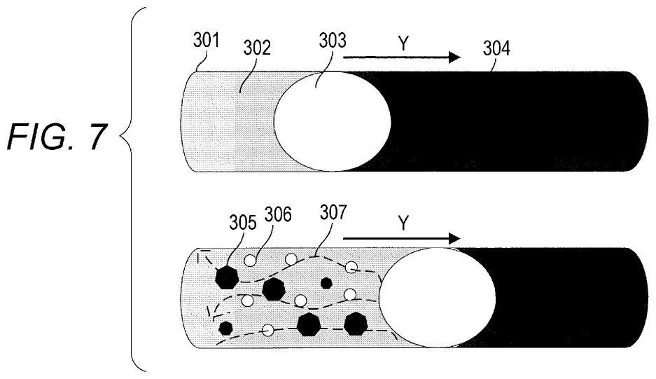

FIG. 7 is a schematic diagram of an aeration cleaning mechanism that introduces the gas into the cleaning liquid in the flow path. The gas introduced into cleaning liquid 302 travels in a flow direction Y of the cleaning liquid as a bubble 303. At that time, on a front side of the bubble 303 (on a side in the flow direction Y of the cleaning liquid with respect to the bubble), a high-speed liquid flow occurs due to an increase in pressure, and a wall surface dirt 304 in the flow path is crushed or peeled off. On the other hand, on a back side of the bubble (on an opposite side in the flow direction Y of the cleaning liquid with respect to the bubble), the pressure drops (depressurized), so that a turbulent flow 307 occurs, and this involves a foreign matter 305 crushed or peeled off by the above-described high-speed liquid flow, thereby removing the foreign matter.

Since the cleaning method according to the present invention generates the bubbles in the inkjet head 110, it is possible to suppress an increase in bubble diameter due to coalescence of the bubbles that occurs from the generation of the bubbles until passage through the nozzle hole 11. Therefore, when passing through the flow path from the fourth communication hole 53 to the nozzle hole 11, the bubbles may maintain the bubble diameter smaller than the flow path diameter of the above-described flow path, so that it is possible to allow more bubbles to pass through the above-described flow path. Since more bubbles pass through the above-described flow path, it is possible to crush or peel off the wall surface dirt on the front side of the bubbles and to involve more foreign matters in the turbulent flow on the back side of the bubbles, so that cleaning efficiency of the flow path and the nozzle hole of the inkjet head 110 is further improved.

On the other hand, in the inventions disclosed in JP 2012-103389 A and JP 2010-228297 A, the bubbles are generated outside the inkjet head, so that a distance from the generation of the bubbles to the passage through the nozzle is longer than that in the present invention. Therefore, as compared with the present invention, the bubble diameter is likely to increase due to the coalescence of the bubbles, a large number of bubbles having a larger bubble diameter than the flow path diameter of the above-described flow path are generated, so that the number of bubbles that may pass through the nozzle decreases. As a result, missing nozzles and deterioration in ink impact accuracy occur.

As described above, the bubbles are made fine by the filter provided on the common ink chamber 2. In contrast, when the bubbles are generated in the inkjet head, the distance from the generation of the bubbles to the passage through the above-described filter is shorter than that when the bubbles are generated outside the inkjet head, so that the bubble diameter at the time of the passage through the filter is smaller when the bubbles are generated in the inkjet head than that when the bubbles are generated outside. Therefore, according to the findings of the present inventors, an average bubble diameter of the bubbles made fine by the above-described filter is smaller when the bubbles are generated in the inkjet head than when they are generated outside. Then, even after the passage through the above-described filter, the bubbles are coalesced again by a turbulent vortex in the flow path and the like, so that it becomes possible to suppress the increase in bubble diameter due to the coalescence of the bubbles and allow more bubbles to pass through the flow path by generating the bubbles in the inkjet head.

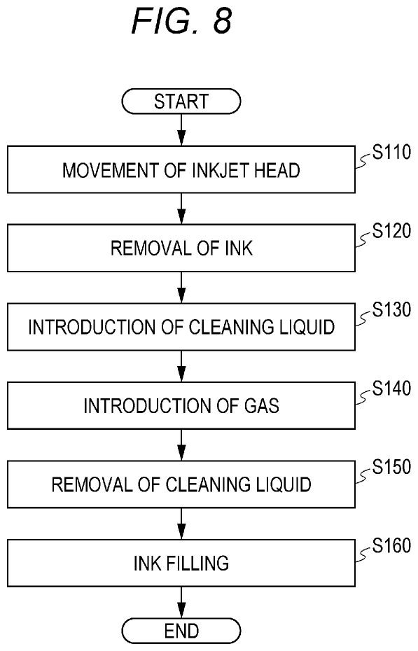

FIG. 8 is an exemplary flowchart of the cleaning method in this embodiment.

As illustrated in FIG. 8, the cleaning method in this embodiment includes a step of moving the inkjet head to the portion above the recovery container (step S110), a step of removing the ink from the flow path in the inkjet head (step S120), a step of introducing the cleaning liquid into the internal flow path in the inkjet head (step S130), a step of introducing the gas into the flow path in the inkjet head (step S140), and a step of removing the cleaning liquid remaining in the inkjet head (step S150).

The cleaning method in this embodiment may further include an ink filling step (step S160). At this step, the inside of the inkjet head is filled with the ink, and a predetermined meniscus is formed on the nozzle hole 11, so that the ink may be easily ejected from the inkjet head 110 next time.

In the image forming device 100, when the input/output interface 60 receives a cleaning job, the control unit 1100 executes the flow illustrated in FIG. 8.

(Step of Moving Inkjet Head (Step S110))

At this step, the inkjet head 110 is moved to the portion above the recovery container 403.

Specifically, at this step, the control unit 1100 controls an operation of the head moving unit drive unit 1700 to move the inkjet head 110 to the position in which the nozzle hole 11 faces the cleaning liquid recovery container 403.

(Step of Removing Ink (Step S120))

At this step, the ink remaining in the flow path in the inkjet head 110 is removed.

Specifically, at this step, the control unit 1100 controls an operation of the pump/valve drive unit 1600 to close the valve 161 and the valve 173, and open the valve 183 so that the gas flow path 182 communicates with the ink discharge port 2b. In this state, the control unit 1100 controls the operation of the pump/valve drive unit 1600 to operate the gas flow path pump 181. As a result, the gas in the gas storage tank 180 passes through the gas flow path 182 and the circulation flow path 164 and is introduced from the ink discharge port 2b into the common ink chamber 2 in the inkjet head 110.

The gas introduced into the common ink chamber 2 passes through the inside of the inkjet head 110 through the fourth communication hole 53, the third communication hole 42, the second communication hole 34, the first communication hole 21, and the nozzle hole 11 in this order, and pushes the ink remaining in the ink flow path out of the nozzle hole 11. As a result, the remaining ink is removed from the inside of the inkjet head 110.

(Step of Introducing Cleaning Liquid (Step S130))

At this step, the cleaning liquid is introduced into the flow path in the above-described inkjet head.

Specifically, at this step, the control unit 1100 controls the operation of the pump/valve drive unit 1600 to open the valve 173 so that the cleaning liquid flow path 172 communicates with the ink flow path 160, and open the valve 161 so that the ink flow path 160 communicates with each of the main flow path 162 and the bypass flow path 163. Furthermore, the control unit 1100 controls the operation of the pump/valve drive unit 1600 to close the valve 152. In this state, the control unit 1100 controls the operation of the pump/valve drive unit 1600 to operate the cleaning liquid flow path pump 171. As a result, the cleaning liquid in the cleaning liquid storage tank 170 passes through the cleaning liquid flow path 172, the ink flow path 160, and each of the main flow path 162 and the bypass flow path 163, and is introduced from the ink supply port 2a to the common ink chamber 2 in the inkjet head 110.

As the above-described cleaning liquid, the known ones may be used within a range in which the effect of the present invention is exhibited, but from the viewpoint of a low cost and excellent drying property, alcohol-based cleaning liquid is preferably used. Specific examples include ethanol, isopropyl alcohol, normal propyl alcohol, isobutyl alcohol and the like.

At that time, the control unit 1100 may control the operation of the pump/valve drive unit 1600 to change a flow rate of the cleaning liquid pushed out of the pump 171 and change the flow rate of the cleaning liquid flowing through the flow path in the inkjet head 110. The flow rate of the cleaning liquid introduced into the above-described flow path is preferably 100 mL/min or larger and 700 mL/min or smaller, more preferably 200 mL/min or larger and 600 mL/min or smaller, and still more preferably 300 mL/min or larger and 500 mL/min or smaller. When this is 100 mL/min or larger, the cleaning efficiency may be improved, and when this is 700 mL/min or smaller, damage to the inkjet head due to an increase in water pressure in the inkjet head may be prevented.

At that time, the control unit 1100 may control the temperature adjustment device 174 or change the temperature of the inkjet head 110 to change the temperature of the cleaning liquid flowing through the flow path in the inkjet head 1110. The temperature of the cleaning liquid is not especially limited within the range in which the effect of the present invention is exhibited, but this is preferably 25° C. or higher and 60° C. or lower, and more preferably 35° C. or higher and 40° C. or lower. When the temperature is 25° C. or higher, a time required for compatibility with the ink is shortened and the cleaning efficiency may be improved, and when the temperature is 60° C. or lower, damage to the device due to evaporation of the alcohol-based cleaning liquid and deterioration in safety are suppressed.

(Step of Introducing Gas (Step S140))

At this step, the gas is introduced into the above-described flow path. The bubbles are generated when the gas is introduced into the cleaning liquid in the above-described flow path.

Specifically, at this step, the control unit 1100 controls the operation of the pump/valve drive unit 1600 to open the valve 183 so that the gas flow path 182 communicates with the ink discharge port 2b. In this state, the control unit 1100 controls the operation of the pump/valve drive unit 1600 to operate the gas flow path pump 181. As a result, the gas in the gas storage tank 180 passes through the gas flow path 182 and the circulation flow path 164 and is introduced from the ink discharge port 2b into the common ink chamber 2 in the inkjet head 110.

A type of the above-described gas is not especially limited within the range in which the effect of the present invention is exhibited. As a specific example, air, oxygen, nitrogen and the like are included, but it is preferable to use air from the viewpoint of simply introducing the gas into the flow path in the inkjet head without using a cylinder and the like.

At that time, the control unit 1100 may control the operation of the pump/valve drive unit 1600 to change a flow rate of the gas pushed out of the pump 181 and change the flow rate of the gas flowing through the flow path in the inkjet head 1110. The flow rate of the gas introduced into the above-described flow path is preferably 50 mL/min or larger and 700 mL/min or smaller, more preferably 80 mL/min or larger and 600 mL/min or smaller, and still more preferably 100 mL/min or larger and 500 mL/min or smaller. When this is 50 mL/min or larger, more bubbles may be generated in the cleaning liquid, and the cleaning effect due to the increase in pressure in the inkjet head may be improved. When this is 700 mL/min or smaller, the average bubble diameter of the bubbles generated in the cleaning liquid does not become too large, and the cleaning effect may be improved.

From the viewpoint of reducing the average bubble diameter of the bubbles generated in the cleaning liquid introduced into the above-described flow path, the porous body 2c is preferably connected to a tip end on the inkjet head side of the gas flow path 192. The pore diameter of the porous body 2c is preferably 10 μm or larger and 30 μm or smaller, more preferably 10 μm or larger and 20 μm or smaller, and still more preferably 10 μm or larger and 15 μm or smaller. The material of the porous body 2c is not especially limited, and known materials may be used.

At that time, the average bubble diameter of the above-described bubbles may be adjusted by the average pore diameter of the above-described porous body 2c. The average bubble diameter of the above-described bubbles is preferably smaller than the flow path diameter in the inkjet head and the ejection port diameter from the viewpoint of allowing the bubbles to pass through the above-described flow path. Specifically, this is preferably 15 μm or larger and 60 μm or smaller, more preferably 15 μm or large and 40 μm or smaller, and still more preferably 15 μm or larger and 35 μm or smaller. Therefore, the average pore diameter of the above-described porous body 2c is preferably 10 μm or larger and 30 μm or smaller, more preferably 10 μm or larger and 20 μm or smaller, and still more preferably 10 μm or larger and 15 μm or smaller.

From the viewpoint of shortening a cleaning time and reducing the used amount of the cleaning liquid and the gas, this step is preferably performed at the same time and finished at the same time as the above (step of introducing the cleaning liquid (S130)).

The washing time is preferably 0.25 minutes or longer and three minutes or shorter, and more preferably 0.5 minutes or longer and two minutes or shorter. When the cleaning time is 0.25 minutes or longer, the cleaning effect may be improved, and when the cleaning time is two minutes or shorter, the used amount of the cleaning liquid and the gas may be reduced. The cleaning time in the present invention refers to a time from the generation of the above-described bubbles in the above-described cleaning liquid introduced into the above-described flow path to the stop of the introduction of the above-described cleaning liquid and the above-described gas.

The internal pressure in the inkjet head is measured by the pressure meter 165. The internal pressure of the inkjet head 110 when the above-described bubbles are generated in the above-described cleaning liquid introduced into the above-described flow path is 0.2 MPa or smaller; this is preferably 0.05 MPa or larger and 0.2 MPa or smaller, more preferably 0.05 MPa or larger and 0.18 MPa or smaller, and still more preferably 0.05 MPa or larger and 0.15 MPa or smaller. When this is 0.05 MPa or larger, the cleaning effect may be improved, and when this is 0.2 MPa or smaller, the damage to the inkjet head 110 may be prevented. The internal pressure of the above-described inkjet head may be adjusted by the flow rate of the cleaning liquid and the flow rate of the gas.

(Relationship Between Cleaning Liquid and Gas)

It is preferable that a flow rate A of the above-described cleaning liquid introduced into the above-described flow path and a flow rate B of the above-described gas introduced into the above-described flow path satisfy equation (1). When the flow rate A of the cleaning liquid and the flow rate B of the gas satisfy equation (1), a pressure difference easily occurs between the front side and the back side of the bubbles in the flow path, and the foreign matter may be easily removed. When the flow rate A of the cleaning liquid and the flow rate B of the gas satisfy equation (1), the internal pressure of the inkjet head 110 is 0.2 MPa or smaller.

1≤A/B≤5 (1)

A/B is preferably 1.5 or larger and 4.5 or smaller (1.5≤A/B≤4.5), and more preferably 2 or larger and 4 or smaller (2≤A/B≤4).

In the inkjet head, an inlet from which the above-described cleaning liquid is introduced is preferably different from an inlet from which the above-described gas is introduced. By doing so, the flow rate of the cleaning liquid introduced into the above-described flow path may be increased, and the installation and operation of the device become simple.

(Step of Removing Cleaning Liquid (Step S150))

At this step, the cleaning liquid remaining in the inkjet head is removed.

Specifically, at this step, the control unit 1100 controls an operation of the pump/valve drive unit 1600 to close the valve 161 and the valve 173, and open the valve 183 so that the gas flow path 182 communicates with the ink discharge port 2b. In this state, the control unit 1100 controls the operation of the pump/valve drive unit 1600 to operate the gas flow path pump 181. As a result, the gas in the gas storage tank 180 passes through the gas flow path 182 and the circulation flow path 164 and is introduced from the ink discharge port 2b into the common ink chamber 2 in the inkjet head 110.

The gas introduced into the common ink chamber 2 passes through the inside of the inkjet head 110 through the fourth communication hole 53, the third communication hole 42, the second communication hole 34, the first communication hole 21, and the nozzle hole 11 in this order, and pushes the cleaning liquid remaining in the ink flow path out of the nozzle hole 11. As a result, the remaining cleaning liquid is removed from the inside of the inkjet head 110.

(Ink Filling Step (Step S160))

At this step, the ink in the ink storage tank 150 is supplied to the inkjet head 110.

Specifically, at this step, the control unit 1100 controls the operation of the pump/valve drive unit 1600 to open the valve 152, open the valve 173 so that the ink storage tank 150 communicates with the ink flow path 160, and open the valve 161 so that the ink flow path 160 communicates with each of the main flow path 162 and the bypass flow path 163. In this state, the control unit 1100 controls the operation of the pump/valve drive unit 1600 to operate the ink supply pump 151. As a result, the ink in the ink storage tank 150 passes through the ink flow path 160 and each of the main flow path 162 and the bypass flow path 163, and is introduced from the ink supply port 2a to the common ink chamber 2 in the inkjet head 110.

At this step, the ink supplied to the inkjet head 110 is thereafter ejected to the recorded medium M.

Specifically, at this step, the control unit 1100 controls the ejection drive unit 1200, the irradiation drive unit 1300, the conveyance drive unit 1400, and the input/output interface 1500, thereby ejecting the ink from the inkjet head to the recorded medium M based on test image data stored in the storage unit 1140. The control unit 1100 controls the operation of the pump/valve drive unit 1160 to open the valve 183 so that the ink discharge port 2b of the inkjet head 110 communicates with the circulation flow path 164. As a result, excessive ink that is not ejected from the inkjet head 110 is returned to the ink supply device 140 and the inkjet head 110 via the ink flow path 160 and each of the main flow path 162 and the bypass flow path 163.

### 2. Second Embodiment

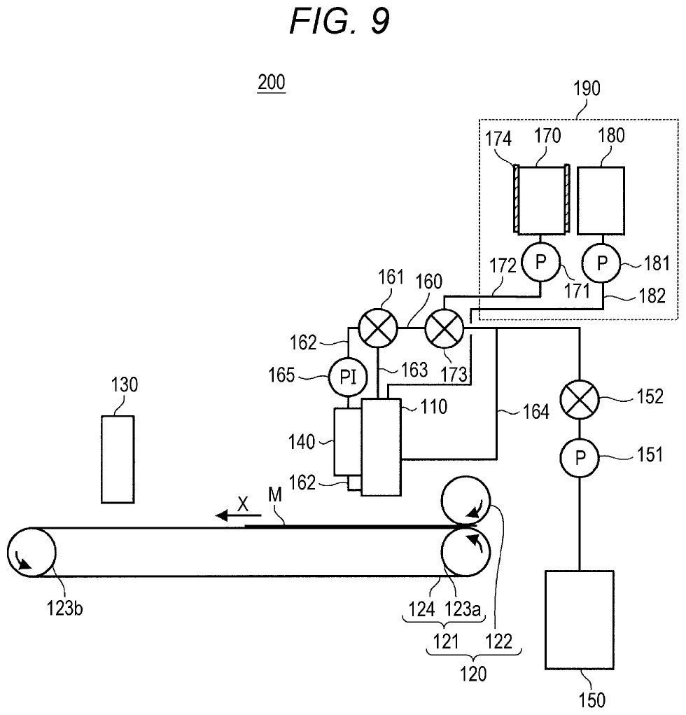

FIG. 9 is a schematic diagram illustrating a configuration of an image forming device according to a second embodiment.

2-1. Image Forming Device

An image forming device 200 in the second embodiment of the present invention is different from the image forming device 100 in the first embodiment in that a gas flow path 182 is inserted from an ink supply port 2a of an inkjet head 210, and cleaning liquid and gas are introduced from the ink supply port 2a. Hereinafter, the common configuration is not described.

2-1-1. Inkjet Head

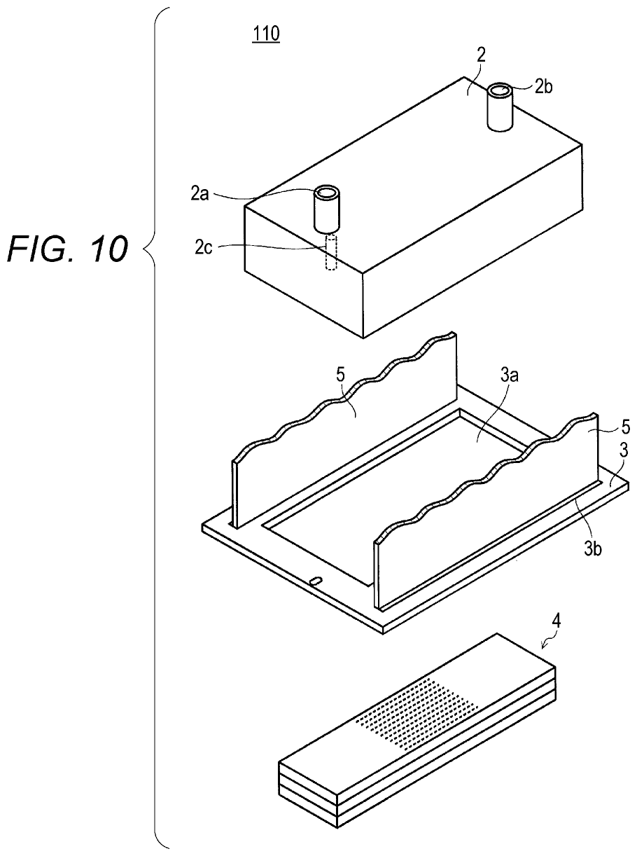

FIG. 10 is an exploded perspective view illustrating an outline of the inkjet head according to the second embodiment.

A configuration of the inkjet head 210 is different from that in the first embodiment in that a porous body 2c is provided on the ink supply port 2a. The porous body 2c is installed so as to cover a part of a bottom surface of the ink supply port 2a. Hereinafter, the common configuration is not described.

2-1-2. Cleaning Device

A configuration of a cleaning device 190 is different from that in the first embodiment in that the porous body 2c is provided on the ink supply port 2a. The porous body 2c is installed so as to cover a part of a bottom surface of the ink supply port 2a. As a result, only the gas may be passed through the porous body. Hereinafter, the common configuration is not described.

The above-described first embodiment and second merely describe an example of substantiation when carrying out the present invention, and the technical scope of the present invention cannot be interpreted in a limited manner by this. That is, the present invention may be variously carried out without departing from the gist or the principal characteristics thereof.

For example, in the above-described embodiment, the image forming device including the irradiation device 130 is described, but the ink to be used may be water-based ink, solvent-based ink and the like in addition to the active ray-curable ink.

Although the bubbles are generated by using the porous body in the above-described embodiment, if the cleaning liquid and the gas may be separately introduced into the inkjet head to generate the bubbles in the inkjet head, another method such as stirring may be used to generate the bubbles.

Although the configuration in which the cleaning device is provided on the image forming device is described in the above-described embodiment, the cleaning device may have a configuration independent from the image forming device, and it is possible to configure to remove the inkjet head from the image forming device to connect the inkjet head to the cleaning device at the time of cleaning

The cleaning may be performed when the image forming device receives the cleaning job or may be performed periodically (after the image is formed a predetermined number of times, when the power is turned on, and when the power is turned off). At that time, the cleaning liquid containing no bubble and the cleaning liquid containing the bubbles may be switched to be used.

Although a piezo type inkjet head including the piezoelectric element is used for description in the above-described embodiment, a nozzle plate including the above-described nozzle plate may be applied to the inkjet head of another system such as a thermal jet type (thermal jet is a registered trademark of Canon Inc.)

Although the porous body is attached to either the ink supply port 2a or the ink discharge port 2b in the above-described embodiment, the porous body may be attached to both of them.

### EXAMPLE

Hereinafter, the present invention is described in more detail with reference to examples, but the scope of the present invention is not interpreted in a limited manner by the description.

An inkjet head used in the examples is used until a sign for replacing inkjet ink appears.

<Measurement of Average Bubble Diameter>

Using a transparent inkjet head made of glass having the same dimension as that of an inkjet head α to be described later, cleaning liquid and air were allowed to flow into an ink inflow unit and an ink discharge unit under conditions of Experiments 1 to 10 described later. At that time, bubbles in the cleaning liquid in the ink discharge unit were imaged by a CCD camera (CS8320B, manufactured by TOKYO DENSHI KOGYO Co., Ltd.), and image processing was performed on the taken image with image processing software (Image-Pro Plus, manufactured by Planetron, Inc.) to measure an average bubble diameter in the cleaning liquid.

<Measurement of Average Pore Diameter of Porous Body>

Using a micro high scope (DSX1000, manufactured by Olympus Corporation), an image of 50 pores of a porous body used in Experiments 1 to 10 described later was taken, and image processing was performed on the taken image with image processing software (Image-Pro Plus, manufactured by Planetron, Inc.) to measure an average pore diameter of the porous body.

### Experiment 1

Using the image forming device described in the first embodiment, isopropyl alcohol as the cleaning liquid was introduced from an ink supply port 2a of the inkjet head α (KM1024iMHE, manufactured by Konica Minolta, Inc.) having the same structure as that of the above-described inkjet head 110 into the inkjet head α at a flow rate A=300 mL/min, and air passing through a porous body a (average pore diameter: 15 μm, manufactured by Hagitec Inc.) was introduced from an ink discharge port 2b into the inkjet head α at a flow rate B=100 mL/min at the same time. An ejection port diameter of the inkjet head used at that time was 40 μm, an average bubble diameter of the generated bubbles was 35 μm, and an internal pressure of the inkjet head when the cleaning liquid and air were allowed to flow in was 0.08 MPa. The cleaning liquid and air were allowed to flow into the inkjet head for one minute. Thereafter, the air was introduced into the cleaned inkjet head and remaining cleaning liquid was removed.

### Experiments 2 to 8

Experiments were performed as in the above-described <Experiment 1>, except the flow rate A [mL/min] of the cleaning liquid, the flow rate B [mL/min] of the air, the ejection port diameter of the inkjet head, and the average bubble diameter of the generated bubbles were changed as illustrated in Table 1. The above-described average bubble diameter was controlled by changing the porous body a in the above-described <Experiment 1> to any one of a porous body b (average pore diameter: 30 μm), a porous body c (average pore diameter: 10 μm), a porous body d (average pore diameter: 150 μm), and a porous body e (average pore diameter: 20 μm) or by changing a ratio of the flow rate of the cleaning liquid to the flow rate of the air (A/B). The ejection port diameter of the inkjet head was adjusted by changing the inkjet head α in the above-described <Experiment 1> to an inkjet head β (ejection port diameter of 60 μm) or an inkjet heady (ejection port diameter of 30 μm). Both the inkjet head β and the inkjet head y have the same structure as that of the inkjet head 110. Table 1 also illustrates the internal pressure of the inkjet head in each experiment used. The flow rates of the cleaning liquid and the air were adjusted by changing outputs of a cleaning liquid flow path pump 171 and a gas flow path pump 181, respectively.

### Experiment 9

A pipe for introducing air was provided in the middle of a pipe between the cleaning liquid flow path pump and the inkjet heady, and isopropyl alcohol containing bubbles was allowed to flow in from the ink inflow unit of the inkjet head for 0.5 minutes. At that time, the flow rate A of the cleaning liquid was 300 mL/min, the flow rate B of the air was 100 mL/min, and the internal pressure of the inkjet head was 0.05 MPa. Thereafter, the air was introduced into the cleaned inkjet head and remaining cleaning liquid was removed.

### Experiment 10

A pipe for introducing air was provided in the middle of a pipe between the cleaning liquid flow path pump and the inkjet head α, and isopropyl alcohol containing bubbles was allowed to flow in from the ink inflow unit of the inkjet head for one minute. At that time, the flow rate A of the cleaning liquid was 300 mL/min, the flow rate B of the air was 100 mL/min, and the internal pressure of the inkjet head was 0.08 MPa. The bubbles were generated through the porous body a. Thereafter, the air was introduced into the cleaned inkjet head and remaining cleaning liquid was removed.

<Preparation of Yellow UV Ink>

In a stainless beaker, 9.0 parts by mass of pigment dispersant (AJISPER PB824, manufactured by Ajinomoto Fine-Techno Co., Inc., “AJISPER” is a registered trademark of Ajinomoto Co., Inc.), 70.0 parts by mass of active ray-polymerizable compound (tripropylene glycol diaciylate), and 0.02 parts by mass of a polymerization inhibitor (IrgastabUV10, manufactured by BASF SE, “Irgastab” is a registered trademark of the company) were placed, and this was heated and stirred for one hour while being heated by a hot plate at 65° C.

After cooling the above-described mixture to room temperature, 21.0 parts by mass of yellow pigment Pigment Yellow 185 (manufactured by BASF SE) was added thereto. The mixed solution was placed in a glass bottle together with 200 g of zirconia beads having a diameter of 0.5 mm, sealed, and dispersed with a paint shaker for eight hours. Thereafter, the zirconia beads were removed to obtain pigment dispersion liquid.

In a stainless beaker, 5.0% by mass of gelling agent “Lunac BA” (behenic acid, manufactured by Kao Corporation., “Lunac” is a registered trademark of the company), 29.9% by mass of active ray-polymerizable compound (polyethylene glycol #400 diaciylate), 23.0% by mass of 6E0-modified trimethylolpropane triacylate, 15.0% by mass of 4E0-modified pentaerythritol tetraacrylate, 8.0% by mass of polymerization initiator “IRGACURE 819” (manufactured by BASF SE, “IRGACURE” is a registered trademark of BASF SE), 0.1% by mass of surfactant “KF-352” (manufactured by Shin-Etsu Chemical Co., Ltd.), and 19.0% by mass of pigment dispersion liquid were placed, and this was stirred for one hour while being heated by a hot plate at 80° C. Yellow UV ink was obtained by filtering the obtained solution with a Teflon (registered trademark) 3 μm-membrane filter manufactured by ADVANTEC TOYO KAISHA, LTD.

<Evaluation of Ink Ejection Stability>

The cleaned inkjet head α was set on the image forming device, and the above-described yellow UV ink was continuously ejected under conditions of a droplet amount of 3.5 μL, a droplet dropping speed of 7 m/s, an ejection frequency of 40 kHz, and a printing rate of 100%. Thereafter, the number of nozzles (missing nozzles) not ejecting one minute, five minutes, and 10 minutes after the ejection start was counted, and the total number was evaluated according to the following criterion. The cleaned inkjet head β and inkjet head α were also evaluated by a similar method.

⊙: The number of missing nozzles is zero.

◯: The number of missing nozzles is one or more and two or less.

Δ: The number of missing nozzles is three or more and less than 10.

x: The number of missing nozzles is 10 or more.

<Evaluation of Impact Position Accuracy>

The cleaned inkjet head α was set on the image forming device, and an inkjet head unit was set on a conveyance stage of 1 μm-accuracy so that the image may be formed by a one-pass system. A polyethylene film (Taiko polyester film FE #50-FE2001, manufactured by Futamura Chemical Co., Ltd.) cut into a sheet was fixed on the conveyance stage. The ink storage tank 150 was filled with UV ink, the above-described prepared yellow UV ink was ejected from the inkjet head, a plurality of fine lines of a thickness of 0.1 mm was printed, cured with a UV lamp, and evaluated according to the following criterion. The cleaned inkjet head β and inkjet head y were also evaluated by a similar method.

◯: The thickness of the thin lines and an interval between adjacent thin lines do not vary, and equivalent images may be obtained repeatedly.

Δ: The thickness of the thin lines and the interval between the adjacent thin lines vary slightly, but the image with no quality problem may be obtained.

x: The thickness of the thin lines and the interval between the adjacent thin lines vary, and the image is not printed correctly.

Table 1 illustrates the conditions and evaluations of Experiments 1 to 10.

TABLE 1

| | CONDITION | | | | | | | | | |
|---|---|---|---|---|---|---|---|---|---|---|
| | | | | | | | | INKJET | | |
| | | CLEANING | | | | | INKJET | HEAD | EVALUATION | |
| | | LIQUID | AIR | | | AVERAGE | HEAD | EJECTION | EJEC- | IMPACT |
| | | FLOW | FLOW | | | BUBBLE | INTERNAL | PORT | TION | POSITION |
| | | RATE A | RATE B | | POROUS | DIAMETER | PRESSURE | DIAMETER | STABIL- | ACCU- |
| | | [mL/min] | [mL/min] | A/B | BODY | [μm] | [MPa] | [μm] | ITY | RACY |
| EXAMPLES | EXPERIMENT 1 | 300 | 100 | 3 | a | 35 | 0.08 | 40 | ⊙ | ◯ |
| | EXPERIMENT 2 | 500 | 100 | 5 | a | 35 | 0.14 | 40 | ◯ | ◯ |
| | EXPERIMENT 3 | 500 | 500 | 1 | b | 45 | 0.2 | 60 | ◯ | ◯ |
| | EXPERIMENT 4 | 300 | 100 | 3 | c | 15 | 0.08 | 30 | ◯ | ◯ |
| | EXPERIMENT 5 | 300 | 400 | 0.75 | d | 200 | 0.16 | 60 | Δ | Δ |
| | EXPERIMENT 6 | 400 | 60 | 6.7 | c | 30 | 0.08 | 40 | Δ | Δ |
| | EXPERIMENT 7 | 500 | 500 | 1 | b | 45 | 0.2 | 30 | Δ | Δ |
| | EXPERIMENT 8 | 300 | 100 | 3 | e | 35 | 0.08 | 30 | Δ | Δ |
| COMPARA- | EXPERIMENT 9 | 300 | 100 | 3 | — | 500 | 0.05 | 30 | X | X |
| TIVE | EXPERIMENT 10 | 300 | 100 | 3 | a | 35 | 0.08 | 40 | X | X |
| EXAMPLES | | | | | | | | | | |

<Results and Study>

Experiments 1 to 8 showed better results than those of Experiments 9 and 10 in terms of both ejection stability and impact position accuracy. It may be considered that, since the bubbles were generated in the inkjet head, an increase in bubble diameter due to coalescence of the bubbles could be suppressed, and many bubbles passed through the flow path and the ejection port, so that the cleaning efficiency was improved and the ejection stability and impact position accuracy were improved.

Experiments 1 to 4 showed better results than those of Experiments 5 and 6 in terms of both ejection stability and impact position accuracy. It may be considered that, since the relationship between the cleaning liquid flow rate A and the air flow rate B satisfied equation (1), a pressure difference was generated between the front side and the back side of the bubbles and the cleaning effect was promoted.

Experiments 1 to 4 showed better results than those of Experiments 7 and 8 in terms of both ejection stability and impact position accuracy. It may be considered that, since the size of the generated bubbles was smaller than the inkjet head ejection port diameter, many bubbles passed through the flow path and the ejection port, so that the cleaning efficiency was improved and the ejection stability and impact position accuracy were improved. In Experiments 7 and 8, although the size of the generated bubbles was larger than the inkjet head ejection port diameter, the bubbles were generated in the inkjet head, so that an increase in bubble diameter due to the coalescence of the bubbles could be suppressed as compared with a case of generating the bubbles outside. Therefore, it is considered that the results were better than those of Experiments 9 and 10.

### INDUSTRIAL APPLICABILITY

The cleaning method of the present invention makes it possible to suppress the missing nozzle and to improve the impact position accuracy of the ink droplets in the cleaned inkjet head. Therefore, it is expected that the present invention further facilitates the image formation by the inkjet method and contributes to the development and popularization of the technology in this field.

Although embodiments of the present invention have been described and illustrated in detail, the disclosed embodiments are made for purposes of illustration and example only and not limitation. The scope of the present invention should be interpreted by terms of the appended claims

What is claimed is:

1. A cleaning method of a flow path in an inkjet head, comprising:
introducing cleaning liquid into the flow path in the inkjet head; and
introducing gas into the flow path in the inkjet head, wherein
bubbles made of the gas are generated in the cleaning liquid introduced into the flow path.

2. The cleaning method of the flow path in the inkjet head according to claim 1, wherein
the introducing the cleaning liquid and the introducing the gas are simultaneously performed.

3. The cleaning method of the flow path in the inkjet head according to claim 1, wherein
the introducing the gas is introducing the gas from an introducing port different from an introducing port from which the cleaning liquid is introduced to the flow path.

4. The cleaning method of the flow path in the inkjet head according to claim 1, wherein
an internal pressure in the inkjet head when a flow rate A of the cleaning liquid introduced into the flow path and a flow rate B of the gas introduced into the flow path satisfy equation (1) and the bubbles are generated is 0.2 MPa or smaller:
1≤A/B≤5 (1).

5. The cleaning method of the flow path in the inkjet head according to claim 1, wherein
an average bubble diameter of the generated bubbles is smaller than an ejection port diameter of the inkjet head.

6. The cleaning method of the flow path in the inkjet head according to claim 1, wherein
the introducing the gas is introducing the gas through a porous body connected to a tip end of a pipe.

7. An inkjet head capable of cleaning a flow path by introducing cleaning liquid and gas into the flow path in the inkjet head, wherein
a porous body that makes the gas fine is arranged in an introducing port from which the gas is introduced.

8. The inkjet head according to claim 7, wherein
the porous body has an average pore diameter smaller than an ejection port diameter of the inkjet head.

9. A cleaning device capable of being mounted on an image forming device including an inkjet head, the cleaning device comprising:
a cleaning liquid introducer that introduces cleaning liquid into a flow path in the inkjet head;
a gas introducer that introduces gas into a flow path in the inkjet head; and
a bubble generator that generates bubbles made of the gas in the cleaning liquid introduced into the flow path.

10. An inkjet image forming device comprising:
an inkjet head; and
the cleaning device according to claim 9.
